(19) United States
(12) Patent Application Publication
(10) Pub. No.: US 2026/0058061 A1
(43) Pub. Date: Feb. 26, 2026

(54) MULTILAYER CERAMIC CAPACITOR AND METHOD FOR MANUFACTURING MULTILAYER CERAMIC CAPACITOR

(71) Applicant: Murata Manufacturing Co., Ltd., Nagaokakyo-shi (JP)

(72) Inventors: Syouta IKEBE, Nagaokakyo-shi (JP); Kazuki YOSHINO, Nagaokakyo-shi (JP)

(21) Appl. No.: 19/374,411

(22) Filed: Oct. 30, 2025

Related U.S. Application Data
(63) Continuation of application No. PCT/JP2024/023711, filed on Jul. 1, 2024.

(30) Foreign Application Priority Data
Aug. 25, 2023 (JP) 2023-137176

(51) Int. Cl. H01G 4/224; H01G 4/008; H01G 4/12; H01G 4/232; H01G 4/248; H01G 4/30; H01G 13/00

(52) U.S. Cl. CPC H01G 4/224; H01G 4/008; H01G 4/1209; H01G 4/2325; H01G 4/248; H01G 4/30; H01G 13/003; H01G 13/006

(57) ABSTRACT

A multilayer ceramic capacitor includes a multilayer body including laminated ceramic layers and laminated inner electrode layers, a barrier film on the multilayer body; and outer electrodes on the barrier film at both end surfaces of the multilayer body. The ceramic layers include a perovskite compound represented by the general formula ABO₃, where the A-site is Ba. The barrier film includes Ba and at least one of S or C. The barrier film covers main surfaces and side surfaces, and also covers the end surfaces except for exposed surfaces at which the inner electrode layers are exposed. The outer electrodes are in contact with the inner electrode layers at the exposed surfaces.

### CROSS REFERENCE TO RELATED APPLICATIONS

This application claims the benefit of priority to Japanese Patent Application No. 2023-137176 filed on Aug. 25, 2023 and is a Continuation Application of PCT Application No. PCT/JP2024/023711 filed on Jul. 1, 2024. The entire contents of each application are hereby incorporated herein by reference.

### BACKGROUND OF THE INVENTION

### 1. Field of the Invention

The present invention relates to multilayer ceramic capacitors and methods for manufacturing the multilayer ceramic capacitors.

### 2. Description of the Related Art

In recent years, multilayer ceramic electronic components, as typified by a multilayer ceramic capacitor, have come to be used in harsher environments than before.

A common multilayer ceramic capacitor includes a capacitive element (component body) composed of a laminate of ceramic layers and inner electrode layers, and outer electrodes formed on the outer surface of the capacitive element. The inner electrode layers are extended to the end surfaces and side surfaces of the capacitive element, and connected to the outer electrodes. The outer electrodes are each composed of a base electrode which has been formed, for example, by applying a conductive paste and firing it, and a plating layer formed on the outer surface of the base electrode. The plating layer is composed of multiple layers as necessary.

Japanese Unexamined Patent Application Publication No. 2019-96862, for example, discloses a multilayer ceramic capacitor which, in order to ensure its moisture resistance reliability, has a first electrode layer including titanium nitride (TiN), which has been formed by atomic layer deposition on the entire surface of a multilayer body including ceramic layers and inner electrode layers, and a second electrode layer disposed on the first electrode layer. With the thin and dense first electrode layer formed on the body, the multilayer ceramic capacitor disclosed in Japanese Unexamined Patent Application Publication No. 2019-96862 can ensure sufficient moisture resistance reliability even when its outer electrodes are thin. The first electrode layer thus performs the function of preventing entry of moisture from the outside into the inner electrode layers.

Focusing on the problem of ESR, Japanese Unexamined Patent Application Publication No. 2019-117942 discloses a structure in which a plurality of grooves are formed in ceramic layers such that end portions of inner electrode layers are exposed on the end surfaces of a multilayer body where outer electrodes are formed. The outer electrodes include a conductive resin layer containing metal particles, a resin, etc., and an electrode layer on the conductive resin layer. An intermetallic compound is formed in the grooves upon the formation of the conductive resin layer. The intermetallic compound ensures electrical conductivity between the exposed end portions of the inner electrode layers and the outer electrodes.

Recently, multilayer ceramic capacitors are rapidly becoming smaller, and are increasingly required to have higher characteristics, higher reliability and lower resistance.

With reference to the multilayer ceramic capacitor disclosed in Japanese Unexamined Patent Application Publication No. 2019-96862, to ensure the moisture resistance reliability causes the problem of increased equivalent series resistance (ESR). Thus, there is a trade-off between them. While the structure disclosed in Japanese Unexamined Patent Application Publication No. 2019-117942 can possibly alleviate the problem of ESR, the document does not disclose a way to ensure moisture resistance reliability, and thus has a problem with moisture resistance reliability. Thus, there has been a demand for a multilayer ceramic capacitor which has a reduced size and yet can stably achieve both high reliability and low resistance.

### SUMMARY OF THE INVENTION

Example embodiments of the present invention provide multilayer ceramic capacitors and methods for manufacturing multilayer ceramic capacitors, each of which are able to ensure moisture resistance reliability by preventing entry of moisture from the outside into the multilayer ceramic capacitor, and each of which are able to achieve a reduction in ESR.

A multilayer ceramic capacitor according to an example embodiment of the present invention includes a multilayer body including a plurality of laminated ceramic layers, a plurality of laminated inner electrode layers, a first main surface and a second main surface which oppose each other in a height direction, a first side surface and a second side surface which oppose each other in a width direction perpendicular or substantially perpendicular to the height direction, and a first end surface and a second end surface which oppose each other in a length direction perpendicular or substantially perpendicular to the height direction and the width direction, a barrier film on the multilayer body, and outer electrodes on the barrier film at the first end surface and the second end surface. The ceramic layers include a perovskite compound represented by the general formula ABO₃, where the A-site is Ba. The barrier film includes Ba and at least one of S or C. The barrier film covers the first main surface, the second main surface, the first side surface, and the second side surface, and also covers the first end surface and the second end surface except for exposed surfaces of the first end surface and the second end surface at which the inner electrode layers are exposed in the multilayer body. The outer electrodes are in contact with the inner electrode layers at the exposed surfaces.

Multilayer ceramic capacitors according to example embodiments of the present invention are each able to achieve a reduction in ESR while ensuring moisture resistance reliability.

A method for manufacturing a multilayer ceramic capacitor according to an example embodiment of the present invention includes preparing, through firing, a multilayer body including a plurality of laminated ceramic layers including a perovskite compound represented by the general formula ABO₃, where an A-site is Ba, a plurality of laminated inner electrode layers, a first main surface and a second main surface which oppose each other in a height direction, a first side surface and a second side surface which oppose each other in a width direction perpendicular or substantially perpendicular to the height direction, and a first end surface and a second end surface which oppose each other in a length direction perpendicular or substantially perpendicular to the height direction and the width direction, forming a barrier film, including Ba and at least one of S and C, on the multilayer body by immersing the multilayer body in a solution including at least one of S ions or C ions, and forming outer electrodes on the barrier film at the first end surface and the second end surface. The barrier film covers the first main surface, the second main surface, the first side surface, and the second side surface, and also covers the first end surface and the second end surface except for exposed surfaces of the first end surface and the second end surface where the inner electrode layers are exposed in the multilayer body. The outer electrodes are in contact with the inner electrode layers at the exposed surfaces.

Methods for manufacturing multilayer ceramic capacitors according to example embodiments of the present invention each make it possible to obtain a multilayer ceramic capacitor which is able to achieve a reduction in ESR while ensuring moisture resistance reliability.

Example embodiments of the present invention provide multilayer ceramic capacitors and methods for manufacturing the multilayer ceramic capacitors, which are each able to ensure moisture resistance reliability by preventing entry of moisture from the outside into the multilayer ceramic capacitor, and which are each able to achieve a reduction in ESR.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective external view showing an example of a multilayer ceramic capacitor according to an example embodiment of the present invention.

FIG. 2 is a sectional view taken along line II-II of FIG. 1.

FIG. 3 is a sectional view taken along line III-III of FIG. 1.

FIG. 4 is an enlarged view of area A of FIG. 2.

FIG. 5 is a flow diagram illustrating a method for manufacturing the multilayer ceramic capacitor of FIG. 1 according to an example embodiment of the present invention, in particular a method for forming a barrier film and outer electrodes.

FIGS. 6A through 6C are schematic sectional diagrams schematically illustrating a method for forming a barrier film and outer electrodes of a multilayer ceramic capacitor according to an example embodiment of the present invention.

FIG. 7 is a schematic sectional view of a multilayer ceramic capacitor of Comparative Example.

FIG. 8 is a schematic diagram illustrating an experimental method for checking conductivity.

### DETAILED DESCRIPTION OF THE EXAMPLE EMBODIMENTS

Example embodiments of the present invention will be described in detail below with reference to the drawings.

### 1. Multilayer Ceramic Capacitor

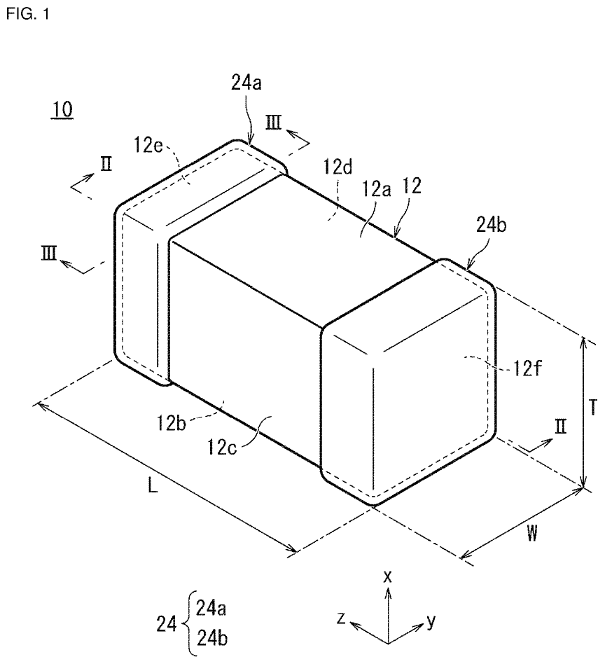

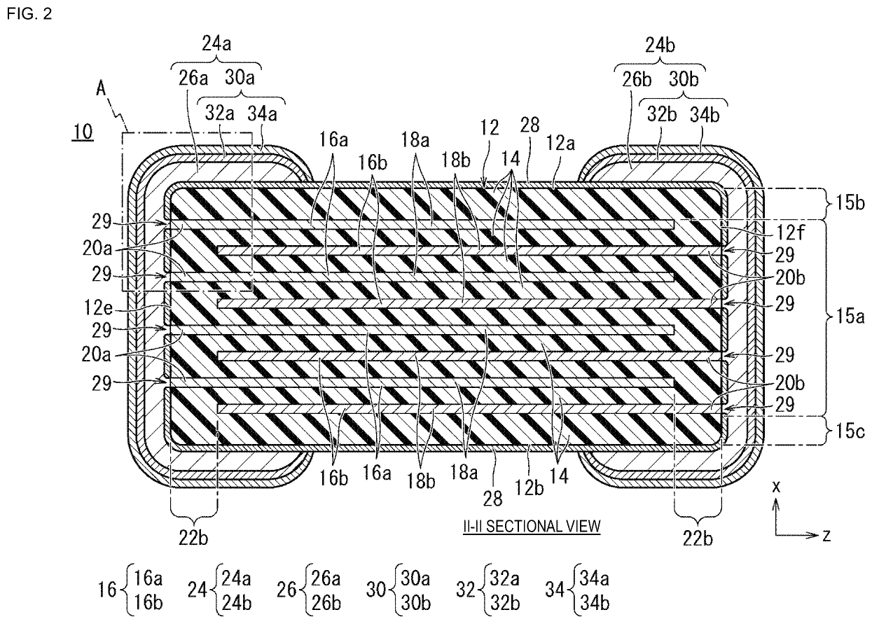

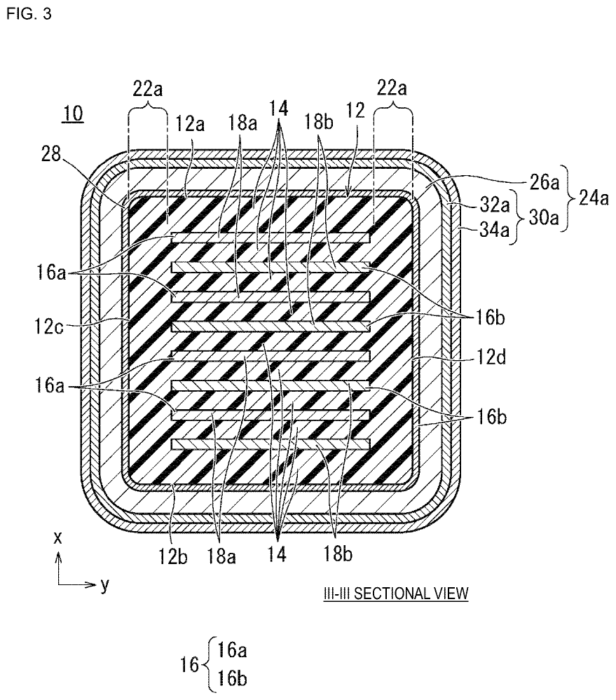

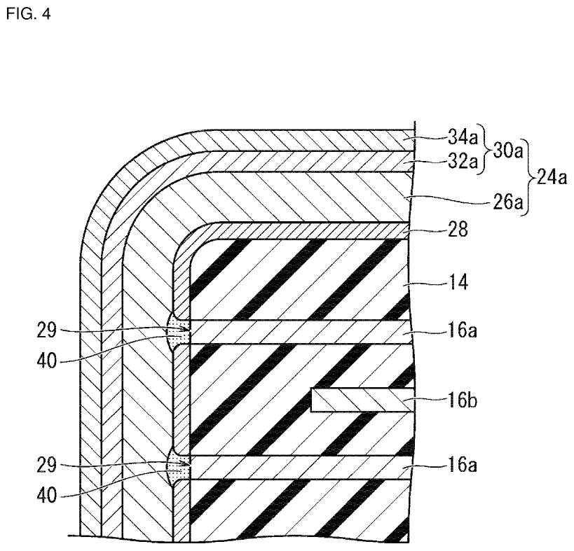

A multilayer ceramic capacitor according to an example embodiment of the present invention will now be described. FIG. 1 is a perspective external view showing an example of a multilayer ceramic capacitor according to an example embodiment of the present invention. FIG. 2 is a sectional view taken along line II-II of FIG. 1. FIG. 3 is a sectional view taken along line III-III of FIG. 1. FIG. 4 is an enlarged view of area A of FIG. 2.

As shown in FIGS. 1 through 3, a multilayer ceramic capacitor 10 includes a multilayer body 12 having a rectangular or substantially rectangular parallelepiped shape, a barrier film 28, and outer electrodes 24.

The multilayer body 12 includes a plurality of laminated ceramic layers 14 and a plurality of laminated inner electrode layers 16. The multilayer body 12 includes a first main surface 12a and a second main surface 12b which oppose each other in the height direction x, a first side surface 12c and a second side surface 12d which oppose each other in the width direction y perpendicular or substantially perpendicular to the height direction x, and a first end surface 12e and a second end surface 12f which oppose each other in the length direction z perpendicular or substantially perpendicular to the height direction x and the width direction y. The multilayer body 12 is preferably rounded at the corners and the ridges. A corner refers to a portion where three adjacent surfaces of the multilayer body intersect, and a ridge refers to a portion where two adjacent surfaces of the multilayer body intersect. Unevenness or the like may be provided on a portion or all of the first main surface 12a and the second main surface 12b, the first side surface 12c and the second side surface 12d, and the first end surface 12e and the second end surface 12f. The dimension of the multilayer body 12 in the length direction z is not necessarily larger than the dimension in the width direction y.

The number of the ceramic layers 14, including outer layers, is, for example, preferably not less than 15 and not more than 700.

The multilayer body 12 includes an effective layer portion 15a where the inner electrode layers 16 face each other in the lamination direction connecting the first main surface 12a and the second main surface 12b, a first outer layer portion 15b located between the first main surface 12a and the inner electrode layer 16 closest to the first main surface 12a, and a second outer layer portion 15c located between the second main surface 12b and the inner electrode layer 16 closest to the second main surface 12b.

The first outer layer portion 15b is an assembly including a plurality of ceramic layers 14 located on the first main surface 12a side of the multilayer body 12, and located between the first main surface 12a and the inner electrode layer 16 closest to the first main surface 12a.

The second outer layer portion 15c is an assembly including a plurality of ceramic layers 14 located on the second main surface 12b side of the multilayer body 12, and located between the second main surface 12b and the inner electrode layer 16 closest to the second main surface 12b.

The area sandwiched between the first outer layer portion 15b and the second outer layer portion 15c is the effective layer portion 15a.

While the dimensions of the multilayer body 12 are not particularly limited, for example, the dimension in the length direction z is preferably not less than about 0.2 mm and not more than about 10.0 mm, a dimension in the width direction y is preferably not less than about 0.1 mm and not more than about 10.0 mm, and a dimension in the height direction x is preferably not less than about 0.1 mm and not more than about 5.0 mm.

The ceramic layers 14 can be made, for example, by using a dielectric material as a ceramic material. Such a dielectric material includes a perovskite compound represented by the general formula ABO₃, where the A-site is Ba. For example, a dielectric ceramic material including a component such as BaTiO₃ can be used as the dielectric material. When the dielectric material includes such a compound as a main component, the material may include a secondary component, such as, for example, a Mn compound, an Fe compound, a Cr compound, a Co compound, or a Ni compound, in a smaller amount than the main component, depending on the desired characteristics of the multilayer body 12.

The thickness of each ceramic layer 14 after firing is, for example, preferably not less than about 0.4 μm and not more than about 10.0 μm.

As shown in FIGS. 2 and 3, the multilayer body 12 includes, for example, as the inner electrode layers 16, a plurality of rectangular or substantially rectangular first inner electrode layers 16a and a plurality of generally rectangular second inner electrode layers 16b. The first inner electrode layers 16a and the second inner electrode layers 16b are embedded such that they are alternately arranged at regular intervals in the lamination direction of the multilayer body 12. The first inner electrode layers 16a and the second inner electrode layers 16b may be arranged such that they are parallel or substantially parallel to a mounting surface, or perpendicular or substantially perpendicular to the mounting surface.

Each first inner electrode layer 16a includes a first opposing electrode portion 18a opposing the second inner electrode layers 16b, and a first extended electrode portion 20a defining one end portion of the first inner electrode layer 16a and extending from the first opposing electrode portion 18a to the first end surface 12e of the multilayer body 12. The end portion of the first extended electrode portion 20a is extended to and exposed on the first end surface 12e.

Each second inner electrode layer 16b includes a second opposing electrode portion 18b opposing the first inner electrode layers 16a, and a second extended electrode portion 20b defining one end portion of the second inner electrode layer 16b and extending from the second opposing electrode portion 18b to the second end surface 12f of the multilayer body 12. The end portion of the second extended electrode portion 20b is extended to and exposed on the second end surface 12f.

While the shape of the first opposing electrode portion 18a of each first inner electrode layer 16a and the shape of the second opposing electrode portion 18b of each second inner electrode layer 16b are not particularly limited, the portions 18a and 18b preferably have, for example, a rectangular or substantially rectangular shape, although the corner portions may be rounded or provided at an angle (tapered).

While the shape of the first extended electrode portion 20a of each first inner electrode layer 16a and the shape of the second extended electrode portion 20b of each second inner electrode layer 16b are not particularly limited, the portions 20a and 20b preferably have, for example, a rectangular or substantially rectangular shape, though the corner portions may be rounded or provided at an angle (tapered).

The first opposing electrode portion 18a of each first inner electrode layer 16a and the first extended electrode portion 20a of the first inner electrode layer 16a may have the same or substantially the same width, or one of them may be narrower. Similarly, the second opposing electrode portion 18b of each second inner electrode layer 16b and the second extended electrode portion 20b of the second inner electrode layer 16b may have the same or substantially the same width, or one of them may be narrower.

The multilayer body 12 includes side portions (W gaps) 22a provided between the first side surface 12c and one-side ends of the first opposing electrode portions 18a and the second opposing electrode portions 18b in the width direction y, and between the second side surface 12d and the other ends of the first opposing electrode portions 18a and the second opposing electrode portions 18b in the width direction y. Further, the multilayer body 12 includes end portions (L gaps) 22b provided between the second end surface 12f and the ends of the first inner electrode layers 16a opposite from the first extended electrode portions 20a, and between the first end surface 12e and the ends of the second inner electrode layers 16b opposite from the second extended electrode portions 20b.

The inner electrode layers 16 include an appropriate conductive material, for example, a metal such as Ni, Cu, Ag, Pd, or Au, or an alloy including at least one of these metals, such as a Ag—Pd alloy, for example. The inner electrode layers 16 may further include dielectric particles having the same compositional system as the ceramic material included in the ceramic layers 14.

The thickness of each inner electrode layer 16 is, for example, preferably not less than about 0.2 μm and not more than about 2.0 μm. The number of the inner electrode layers 16 is, for example, preferably not less than 15 and not more than 200.

The barrier film 28 is disposed on the multilayer body 12. In particular, the barrier film 28 covers the first main surface 12a, the second main surface 12b, the first side surface 12c, and the second side surface 12d, and also covers the first end surface 12e and the second end surface 12f except for exposed surfaces 29 of the first end surface 12e and the second end surface 12f where the inner electrode layers 16 are exposed in the multilayer body 12. The end portions of the first extended electrode portions 20a are extended to and exposed on the first end surface 12e, and the end portions of the second extended electrode portions 20b are extended to and exposed on the second end surface 12f. The exposed surfaces 29 thus exist. At the first end surface 12e and the second end surface 12f, the barrier film 28 does not cover the exposed surfaces 29. The exposed surfaces 29 are covered by the outer electrodes 24.

The barrier film 28 includes Ba and at least one of S and C. For example, the barrier film 28 includes BaSO₄, BaCO₃, or the like. BaSO₄ and BaCO₃ are not readily soluble in water. Therefore, the use of the barrier film 28 made of one of them can further prevent the entry of a liquid, such as moisture, from the outside into the multilayer body 12.

The outer electrodes 24 are disposed on the first end surface 12e side and the second end surface 12f side of the multilayer body 12. The outer electrodes 24 include a first outer electrode 24a and a second outer electrode 24b.

The outer electrodes 24 include a base electrode layer 26 including a metal component and a glass component, and a plating layer 30 provided on the surface of the base electrode layer 26.

The first outer electrode 24a, in its first end surface 12e-side portion, is disposed on the surface of the barrier film 28, and is connected to the first inner electrode layers 16a at the exposed surfaces 29. The first outer electrode 24a extends from the first end surface 12e-side portion such that its first main surface 12a-side portion, second main surface 12b-side portion, first side surface 12c-side portion, and second side surface 12d-side portion are disposed on the surface of the barrier film 28. In this case, the first outer electrode 24a is electrically connected to the first extended electrode portions 20a of the first inner electrode layers 16a.

The second outer electrode 24b, in its second end surface 12f-side portion, is disposed on the surface of the barrier film 28, and is connected to the second inner electrode layers 16b at the exposed surfaces 29. The second outer electrode 24b extends from the second end surface 12f-side portion such that its first main surface 12a-side portion, second main surface 12b-side portion, first side surface 12c-side portion, and second side surface 12d-side portion are disposed on the surface of the barrier film 28. In this case, the second outer electrode 24b is electrically connected to the second extended electrode portions 20b of the second inner electrode layers 16b.

In the multilayer body 12, the first opposing electrode portions 18a of the first inner electrode layers 16a and the second opposing electrode portions 18b of the second inner electrode layers 16b face each other via the ceramic layers 14, thus generating an electrostatic capacitance. Thus, an electrostatic capacitance can be obtained between the first outer electrode 24a to which the first inner electrode layers 16a are connected, and the second outer electrode 24b to which the second inner electrode layers 16b are connected, thus providing capacitor characteristics.

The base electrode layer 26 includes a first base electrode layer 26a and a second base electrode layer 26b.

The first base electrode layer 26a, in its first end surface 12e-side portion, is disposed on the surface of the barrier film 28, and is connected to the first inner electrode layers 16a at the exposed surfaces 29. As shown in FIG. 4, an alloy layer 40 is formed on the exposed surfaces 29 by, for example, mutual diffusion of Cu from the first base electrode layer 26a and Ni from the first inner electrode layers 16a. The alloy layer 40 is denser than the first inner electrode layers 16a and the first base electrode layer 26a themselves. This can improve the bond strength between the first base electrode layer 26a and the first inner electrode layers 16a, thus further reducing the ESR.

The first base electrode layer 26a extends from the first end surface 12e-side portion such that it partially covers the surface of the barrier film 28 on each of the first main surface 12a side, the second main surface 12b side, the first side surface 12c side, and the second side surface 12d side.

The second base electrode layer 26b, in its second end surface 12f-side portion, is disposed on the surface of the barrier film 28, and is connected to the second inner electrode layers 16b at the exposed surfaces 29. As shown in FIG. 4, an alloy layer 40 is formed on the exposed surfaces 29 by, for example, mutual diffusion of Cu from the second base electrode layer 26b and Ni from the second inner electrode layers 16b. The alloy layer 40 is denser than the second inner electrode layers 16b and the second base electrode layer 26b themselves. This can improve the bond strength between the second base electrode layer 26b and the second inner electrode layers 16b, thus further reducing the ESR.

The second base electrode layer 26b extends from the second end surface 12f-side portion such that it partially covers the surface of the barrier film 28 on each of the first main surface 12a side, the second main surface 12b side, the first side surface 12c side, and the second side surface 12d side.

The first base electrode layer 26a may be disposed only on the surface of the barrier film 28 located on the first end surface 12e of the multilayer body 12. The second base electrode layer 26b may be disposed only on the surface of the barrier film 28 located on the second end surface 12f of the multilayer body 12.

The construction of the base electrode layer 26 will now be described with reference to a case where the above-described baked layer is used as the base electrode layer 26.

The baked layer includes a glass component and a metal component. The glass component of the baked layer includes, for example, at least one of B, Si, Ba, Mg, Al, Li, or the like. The metal component of the baked layer includes, for example, at least one of Cu, Ni, Ag, Pd, a Ag—Pd alloy, Au, or the like. The baked layer may include multiple layers. The baked layer is formed by applying a conductive paste including the glass component and the metal component to the multilayer body 12, and baking the conductive paste. The baked layer may be formed by simultaneously firing a multilayer chip, including inner electrode layers 16 and ceramic layers 14 before firing, and the conductive paste applied to the multilayer chip, or by firing the multilayer chip, including inner electrode layers 16 and ceramic layers 14 before firing, to obtain the multilayer body 12, and then applying the conductive paste to the multilayer body 12 and baking the paste. In the case where the baked layer is formed by simultaneously firing the multilayer chip, including inner electrode layers 16 and ceramic layers 14 before firing, and the conductive paste applied to the multilayer chip, the conductive paste preferably includes a ceramic material instead of the glass component.

The thickness, at the center in the height direction x, of the first and second baked layers included in the first and second base electrode layers 26a and 26b located on the first end surface 12e and the second end surface 12f, is preferably, for example, on the order of not less than about 10 μm and not more than about 160 μm.

When the base electrode layer 26 is provided on the first main surface 12a and the second main surface 12b, and the first side surface 12c and the second side surface 12d, the thickness, at the center in the length direction z, of the first and second baked layers included in the first and second base electrode layers 26a and 26b located on the first main surface 12a and the second main surface 12b, and the first side surface 12c and the second side surface 12d, is preferably, for example, on the order of not less than about 5 μm and not more than about 40 μm.

The plating layer 30 includes a first plating layer 30a and a second plating layer 30b.

The first plating layer 30a and the second plating layer 30b, of the plating layer 30 which can be disposed on the base electrode layer 26, will now be described with reference to FIGS. 2 and 3.

The first plating layer 30a and the second plating layer 30b include, for example, at least one of Cu, Ni, Sn, Ag, Pd, a Ag—Pd alloy, Au, or the like.

The first plating layer 30a is disposed such that it covers the first base electrode layer 26a.

The second plating layer 30b is disposed such that it covers the second base electrode layer 26b.

The first plating layer 30a and the second plating layer 30b may include multiple layers. In that case, the plating layer 30 preferably has a two-layer structure including, for example, a lower plating layer 32 including Ni plating on the base electrode layer 26, and an upper plating layer 34 including Sn plating on the lower plating layer 32.

Thus, the first plating layer 30a includes a first lower plating layer 32a and a first upper plating layer 34a located on the surface of the first lower plating layer 32a.

The second plating layer 30b includes a second lower plating layer 32b and a second upper plating layer 34b located on the surface of the second lower plating layer 32b.

The lower plating layer 32 including Ni plating is used to prevent the base electrode layer 26 from being corroded by solder upon mounting of the multilayer ceramic capacitor 10. The upper plating layer 34 including Sn plating is used to improve the wettability of solder upon mounting of the multilayer ceramic capacitor 10, thus facilitating the mounting.

The thickness of each of the two plating layers is, for example, preferably not less than about 2.0 μm and not more than about 15.0 μm.

The dimension of the multilayer ceramic capacitor 10, including the multilayer body 12, the first outer electrode 24a, and the second outer electrode 24b, in the length direction z is herein referred to as the L dimension, the dimension of the multilayer ceramic capacitor 10, including the multilayer body 12, the first outer electrode 24a, and the second outer electrode 24b, in the height direction x is herein referred to as the T dimension, and the dimension of the multilayer ceramic capacitor 10, including the multilayer body 12, the first outer electrode 24a, and the second outer electrode 24b, in the width direction y is herein referred to as the W dimension.

The dimensions of the multilayer ceramic capacitor 10 are not particularly limited. For example, the L dimension in the length direction z may be not less than about 0.2 mm and not more than about 7.5 mm, the W dimension in the width direction y may be not less than about 0.1 mm and not more than about 3.5 mm, and the T dimension in the height direction x may be not less than about 0.2 mm and not more than about 3.5 mm. The L dimension in the length direction z is not necessarily larger than the W dimension in the width direction y. The dimensions of the multilayer ceramic capacitor 10 can be measured using a microscope, for example.

In the multilayer ceramic capacitor 10 shown in FIG. 1, the first and second main surfaces 12a and 12b and the first and second side surfaces 12c and 12d of the multilayer body 12 are covered with the barrier film 28, and the first and second end surfaces 12e and 12f of the multilayer body 12 are also covered with the barrier film 28 except for the exposed surfaces 29 of the inner electrode layers 16. The exposed surfaces 29 are covered with the first and second outer electrodes 24a and 24b. Thus, the multilayer body 12 is covered with the barrier film 28 and with the first and second outer electrodes 24a and 24b. The barrier film 28 and the first and second outer electrodes 24a and 24b can prevent a liquid, such as moisture, from entering the multilayer body 12 from the outside, thus improving the moisture resistance reliability. It is to be noted in this regard that the formation of grain boundaries, which are boundaries between particles of glass or the like that define the ceramic layers 14 and which are vulnerable to entry of moisture or the like, can lead to damage to the ceramic layers 14. The above-described features of the present example embodiment can prevent the entry of moisture or the like into the multilayer body 12, and can therefore prevent damage to the ceramic layers 14.

According to the above features, the barrier film 28 is provided also between the outer electrodes 24 and the multilayer body 12. Therefore, even when the outer electrodes 24 are damaged, for example, when a hole or the like is present, the barrier film 28 can prevent moisture or the like, which has passed through the outer electrodes 24, from entering the multilayer body 12.

According to the above features, the barrier film 28 is not provided on the exposed surfaces 29, and the inner electrode layers 16 and the outer electrodes 24 are directly connected to each other at the exposed surfaces 29. This can ensure the conductivity between the inner electrode layers 16 and the outer electrodes 24, thus reducing the equivalent series resistance (ESR).

As described hereinabove, the above features make it possible to achieve a reduction in ESR while ensuring moisture resistance reliability.

The barrier film 28 is provided on the entire or substantially the entire surface of the multilayer body 12 except for the exposed surfaces 29. This can prevent the entry of a liquid, such as moisture, from the outside into the multilayer body 12 even when the base electrode layer 26 includes a glass component which is vulnerable to moisture.

### 2. Method for Manufacturing Multilayer Ceramic Capacitor

An example of a method for manufacturing a multilayer ceramic capacitor according to an example embodiment of the present invention will now be described.

First, a ceramic paste including a ceramic powder is applied in a sheet shape, for example, by screen printing, followed by drying to produce a green ceramic sheet.

Next, an inner electrode-forming conductive paste is prepared, and the paste is applied in a predetermined pattern to the green ceramic sheet, for example, by screen printing or gravure printing. Green ceramic sheets including an inner electrode-forming conductive pattern, and green ceramic sheets including no inner electrode-forming conductive pattern are prepared in the above-described manner.

The ceramic paste and the inner electrode-forming conductive paste may each include, for example, a known organic binder or solvent.

Subsequently, a predetermined number of green ceramic sheets for outer layers, including no inner electrode-forming conductive pattern, are stacked. On the resulting stack, green ceramic sheets including an inner electrode-forming conductive pattern are sequentially stacked and, on the resulting stack, a predetermined number of green ceramic sheets including no inner electrode-forming conductive pattern are stacked to produce a mother multilayer body. In the production of the stacked sheets, the stacking of the green ceramic sheets including an inner electrode-forming conductive pattern is performed such that the extended portions of the inner electrode-forming conductive patterns are arranged in an alternate manner.

The stacked sheets are pressure-bonded in the stacking direction by, for example, an isostatic press or the like to produce a multilayer block.

The multilayer block is then cut into green multilayer body chips having predetermined dimensions. The corners and ridges of each multilayer body chip may be rounded by, for example, barrel polishing or the like.

Subsequently, each green multilayer body chip that is cut out is fired to produce a multilayer body 12 including first inner electrode layers and second inner electrode layers, arranged in its interior with the first inner electrode layers being extended to a first end surface and the second inner electrode layers being extended to a second end surface. While the firing temperature for the green multilayer body chip depends on the ceramic material and on the material of the inner electrode-forming conductive paste, it is, for example, preferably not less than about 900° C. and not more than about 1300° C.

Next, a barrier film 28 is formed on the produced multilayer body 12. Prior to the formation of the barrier film 28, it is possible to additionally perform a step of processing the end surfaces 12e and 12f of the multilayer body 12.

The temperature at the start of firing differs between the inner electrode-forming conductive paste and the ceramic paste, and therefore their shrinkages may occur at different times during the firing process. Consequently, in the multilayer body 12 after firing, the end portions of the inner electrode layers 16 are not flush with the end portions of the ceramic layers 14 at the first and second end surfaces 12e and 12f in the length direction z. The end portions of the inner electrode layers 16 are located inward (on the inner side in the length direction z of the multilayer body 12) of the end portions of the ceramic layers 14. Thus, a step is formed between the end portion of each inner electrode layer 16 and the end portion of an adjacent ceramic layer 14. Such steps may cause a reduction in the degree of contact between outer electrodes 24 and the inner electrode layers 16 upon the formation of the outer electrodes 24 on the end portions of the inner electrode layers 16 and the end portions of the ceramic layers 14 at the first and second end surfaces 12e and 12f. In view of this, the multilayer body 12 after firing may be subjected to a treatment, such as a blast treatment, to scrape or grind the end portions of the ceramic layers 14 at the first and second end surfaces 12e and 12f of the multilayer body 12, thereby reducing the heights of the steps, or making the end portions of the inner electrode layers 16 flush with the end portions of the ceramic layers 14.

Subsequently, a barrier film 28 is formed on the multilayer body 12.

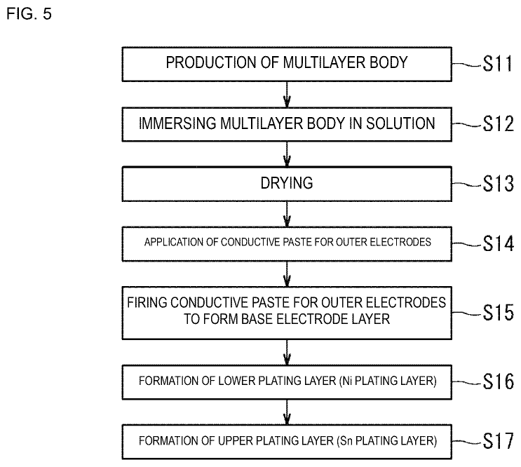

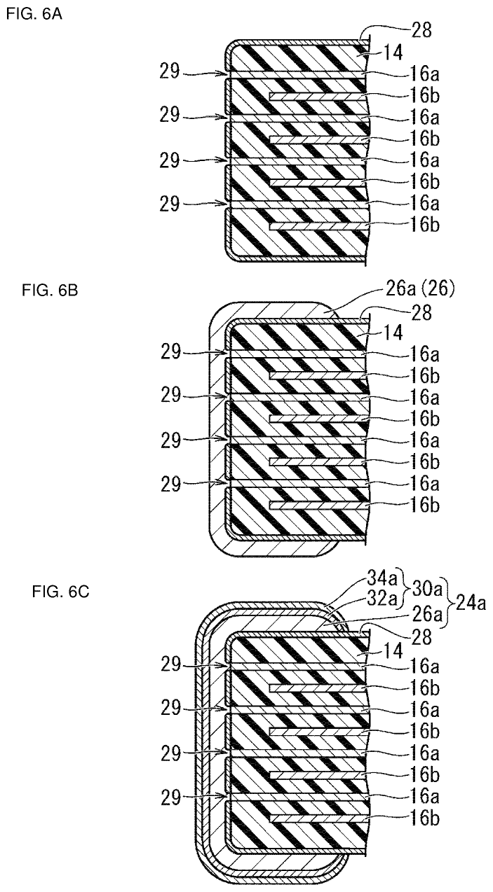

FIG. 5 is a flow diagram illustrating a method for manufacturing the multilayer ceramic capacitor of FIG. 1, in particular an example of a method for forming the barrier film and the outer electrodes. FIGS. 6A through 6C are schematic sectional diagrams schematically illustrating an example of a method for forming the barrier film and the outer electrodes of a multilayer ceramic capacitor according to an example embodiment of the present invention.

First, after the multilayer body 12 is produced (S11), the multilayer body 12 is immersed in a solution (S12). The solution includes, for example, at least one of S ions or C ions. For example, the entire multilayer body 12 is immersed in the solution under room temperature conditions and allowed to stand for about 15 minutes. It is also possible to stir the solution. It is preferred that the solution does not dissolve the inner electrode layers or the multilayer body, and exists as a liquid. Examples of solutions including S ions include solutions of Na₂SO₄, K₂SO₄, CuSO₄, NiSO₄, Al₂(SO₄)₃, or MnSO₄. Examples of solutions containing C ions include solutions of Na₂CO₃, K₂CO₃, CuCO₃, NiCO₃, Al₂(CO₃)₃, or MnCO₃. The concentration of the solution is, for example, about 50 g/l.

A barrier film 28 is thus formed on the multilayer body 12 as shown in FIG. 6A. When the solution includes S ions, Ba in the ceramic layers 14 of the multilayer body 12 reacts with the S ions, forming a barrier film 28 made of BaSO₄ on the multilayer body 12. When the solution includes C ions, Ba in the ceramic layers 14 of the multilayer body 12 reacts with the C ions, forming a barrier film 28 made of BaCO₃ on the multilayer body 12. The solution does not react with the inner electrode layers 16, and therefore a barrier film 28 is not formed on the exposed surfaces 29 of the inner electrode layers 16.

The multilayer body 12 after having been immersed in the solution is removed from the solution and dried (S13). For example, the solution adhering to the multilayer body 12 is removed using a vacuum suction machine (DSC). In this manner, droplets on the barrier film 28 can be removed. A heat treatment using, for example, a dryer at about 100° C. can also be used as a drying method.

Subsequently, outer electrodes 24 are formed on the multilayer body 12.

A conductive paste for outer electrodes is applied to both end surfaces of the multilayer body 12 on which the barrier film 28 has been formed (S14). The applied conductive paste for outer electrodes is then fired to form a baked layer, including a first base electrode layer 26a of a first outer electrode 24a and a second base electrode layer 26b of a second outer electrode 24b, as shown in FIG. 6B (S15). At the exposed surfaces 29, the first and second base electrode layers 26a and 26b are in direct contact with and electrically connected to the first and second inner electrode layers 16a and 16b. As shown in FIG. 4, an alloy layer 40 is formed on the exposed surfaces 29, for example, by Cu diffused from the first and second base electrode layers 26a and 26b and Ni diffused from the first and second inner electrode layers 16a and 16b.

The formation of the baked layer as the base electrode layer 26 is performed by applying the conductive paste containing a glass component and a metal component, for example, by a dip method, followed by baking. The baking temperature is, for example, preferably not less than about 700° C. and not more than about 900° C.

Thereafter, as shown in FIG. 6C, a lower plating layer 32 is formed on the surface of the base electrode layer 26 (S16), and an upper plating layer 34 is formed on the surface of the lower plating layer 32 (S17), such that the formation of the outer electrodes 24 is completed. In the multilayer ceramic capacitor 10 shown in FIG. 1, for example, a Ni plating layer is formed as the lower plating layer 32 formed on the base electrode layer 26, and a Sn plating layer is formed as the upper plating layer 34. The lower plating layer 32 and the upper plating layer 34 are formed by, for example, electrolytic plating or electroless plating. The plating layer preferably includes multiple layers.

The multilayer ceramic capacitor 10 shown in FIG. 1 is manufactured in the above-described manner.

### 3. Experimental Examples

In order to confirm the above-described advantageous effects of the multilayer ceramic capacitor according to the present invention, multilayer ceramic capacitors were produced, and they were subjected to a moisture resistance reliability test and an ESR measurement test.

### (1) Specifications of Sample of Example

First, a multilayer ceramic capacitor of Example of an example embodiment of the present invention, having the following specifications, was produced according to the above-described method for manufacturing a multilayer ceramic capacitor.

### Example

Structure of multilayer ceramic capacitor: 2 terminals (see FIGS. 1 through 3)
Dimensions of multilayer ceramic capacitor L×W×T (including design values): about 1.0 mm×about 0.5 mm×about 0.5 mm
Ceramic layer material: BaTiO₃
Capacitance: about 10 μF
Rated voltage: about 6.3 V
   Structure of inner electrode layers
Metal component: Cu
   Structure of barrier film
Component: BaSO₄
Structure of outer electrodes
   Base electrode layer
Metal component: Ni
Plating layer: two-layer structure of Ni plating layer and Sn plating layer

### (2) Specifications of Sample of Comparative Example

Subsequently, a multilayer ceramic capacitor 10A of Comparative Example, having the following specifications, was produced.

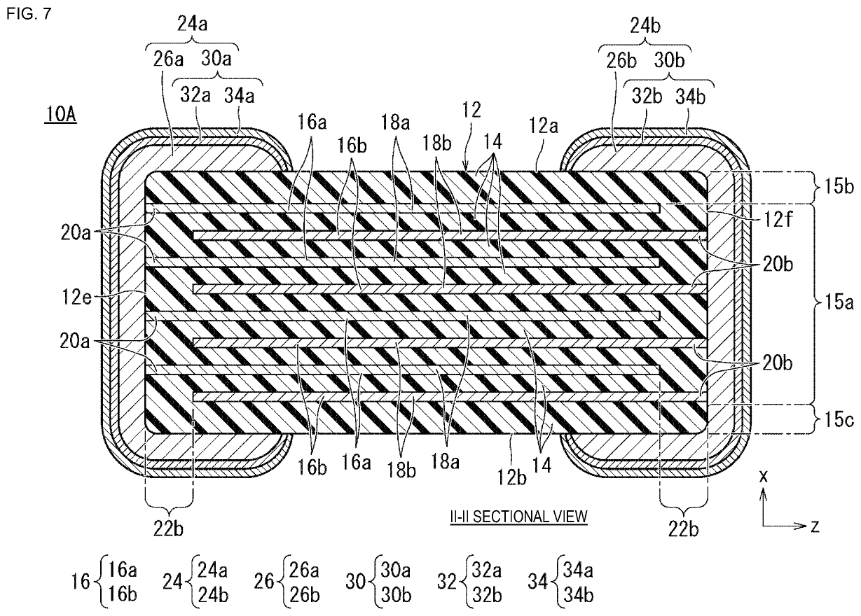

FIG. 7 is a schematic sectional view of the multilayer ceramic capacitor of Comparative Example. The multilayer ceramic capacitor 10A of Comparative Example has the same specifications as the multilayer ceramic capacitor 10 of Example except that the comparative capacitor has no barrier film 28.

### (3) Test Methods

### (a) Moisture Resistance Reliability Test

After mounting samples of Example and samples of Comparative Example on a substrate, the substrate was placed in a high-temperature, high-humidity chamber, and a voltage of about 4 V was applied to each sample for about 200 hours in an environment of about 85° C. and about 85% RH. Subsequently, the insulation resistance of each sample after the moisture resistance reliability test was measured.

The insulation resistance values of each sample before and after the moisture resistance reliability test were compared. Samples which did not show a decrease in the insulation resistance value on the order of one digit or more were evaluated as good. 20 samples were used in each of Example and Comparative Example. In Table 2, “x” indicates that about 10% or more of the samples were evaluated as not good, and “O” indicates otherwise.

### (b) ESR Measurement Test

A cross-section of each sample was processed, and probes were applied to an inner electrode layer and a Sn plating layer to measure an ESR value. A sample was evaluated as good when the ESR value was about 100Ω or less. 7 samples were used in each of Example and Comparative Example. In Table 2, “x” indicates that two or more of the 7 samples were evaluated as not good, and “O” indicates otherwise.

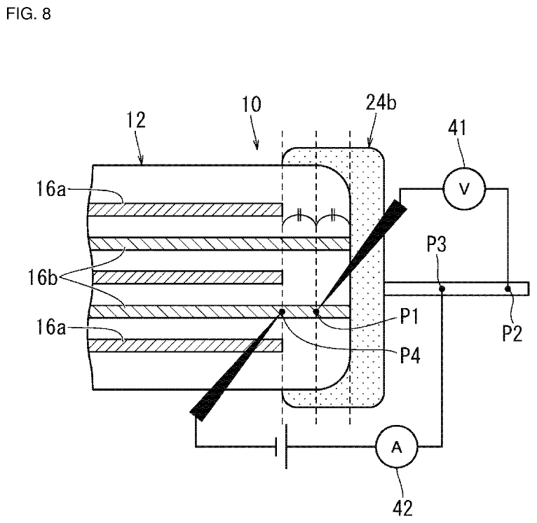

To check the conductivity, each sample was polished to expose an LT cross-section, and then a measuring device having the functions of a voltmeter 41 and an ammeter 42 was attached to positions P1, P2, P3, and P4 shown in FIG. 8, and the resistance between P1 and P3 (2 to 3 cm) was measured by the four-terminal method. A digital multimeter (PC7000, manufactured by Sanwa Electric Instrument Co., Ltd.) was used as, for example, a measuring device to measure the voltage between P1 and P2, and the current between P3 and P4.

When the conductivity between an inner electrode layer and an outer electrode is ensured at a measurement voltage of about 100 mV, it is possible to measure a current of, for example, several hundreds of mA according to Ohm's law. On the other hand, when the conductivity between the inner electrode layer and the outer electrode is poor, a current to be measured will be no more than several tens of mA.

The evaluation results are shown in Table 1.

TABLE 1

| | Comp. Example | Example |
|---|---|---|
| Moisture resistance reliability | x | ∘ |
| test | | |
| ESR measurement test | ∘ | ∘ |

### (4) Experimental Results

In the sample multilayer ceramic capacitor 10 of Example, the barrier film is formed on both end surfaces, both main surfaces, and both side surfaces such that it covers the surfaces of the multilayer body, and the end surfaces are covered with the outer electrodes. Therefore, the sample multilayer ceramic capacitor 10 can prevent the entry of moisture from the outside. As shown in Table 1, the capacitor was evaluated as good in the moisture resistance reliability test.

Further, the sample multilayer ceramic capacitor 10 of Example ensures conductivity between the outer electrodes and the inner electrode layers through the exposed surfaces. As shown in Table 1, the capacitor was evaluated as good in the ESR measurement test. The fact that the sample multilayer ceramic capacitor 10 of Example was evaluated as good in the moisture resistance reliability test as with the sample multilayer ceramic capacitor 10A of Comparative Example indicates that the presence of the barrier film 28 does not reduce or prevent a reduction of ESR. The test results thus reveal that the sample multilayer ceramic capacitor 10 of Example can achieve a reduction in ESR.

On the other hand, since the sample multilayer ceramic capacitor 10A of Comparative Example does not include a barrier film, it was evaluated as not good in the moisture resistance reliability test.

Because of the absence of a barrier film in the sample multilayer ceramic capacitor 10A of Comparative Example, conductivity is ensured between the inner electrode layers and the plating layer. The comparative capacitor was evaluated as good in the ESR measurement test.

As described above, in the multilayer ceramic capacitor 10 according to an example embodiment of the present invention, the barrier film is provided on both end surfaces, both main surfaces, and both side surfaces such that it covers the surfaces of the multilayer body, and the end surfaces are covered with the outer electrodes. Further, conductivity between the outer electrodes and the inner electrode layers is ensured through the exposed surfaces. Therefore, the multilayer ceramic capacitor 10 can reduce or prevent the entry of moisture from the outside, thus improving the moisture resistance reliability, and can achieve a reduction in ESR.

While the barrier film is provided between the outer electrodes and the multilayer body, high moisture resistance reliability and a reduction in ESR resistance are achieved. It is therefore conceivable that the outer electrodes and the barrier film are bound together, and that the presence of the barrier film does not cause peeling or the like of the outer electrodes.

While the present invention has been disclosed above with reference to example embodiments, the present invention is not limited to the example embodiments.

Thus, changes and modifications can be made to the example embodiments described above in terms of mechanism, shape, material, quantity, position, arrangement, etc., without departing from the scope of the technical idea and purpose of the present invention, and such modified example embodiments fall within the scope of the invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of laminated ceramic layers and a plurality of laminated inner electrode layers, a first main surface and a second main surface which oppose each other in a height direction, a first side surface and a second side surface which oppose each other in a width direction perpendicular or substantially perpendicular to the height direction, and a first end surface and a second end surface which oppose each other in a length direction perpendicular or substantially perpendicular to the height direction and the width direction;
a barrier film on the multilayer body; and
outer electrodes on the barrier film at the first end surface and the second end surface; wherein
the plurality of ceramic layers include a perovskite compound represented by a general formula ABO₃, where an A-site is Ba;
the barrier film includes Ba and at least one of S or C;
the barrier film covers the first main surface, the second main surface, the first side surface, and the second side surface, and also covers the first end surface and the second end surface except for exposed surfaces of the first end surface and the second end surface at which the plurality of inner electrode layers are exposed in the multilayer body; and
the outer electrodes are in contact with the plurality of inner electrode layers at the exposed surfaces.

2. The multilayer ceramic capacitor according to claim 1, wherein the barrier film includes at least one of barium sulfate or barium carbonate.

3. The multilayer ceramic capacitor according to claim 1, wherein
the plurality of inner electrode layers include Ni as a main component;
the outer electrodes include a base electrode layer including Cu as a main component, and a plating layer on the base electrode layer; and
the plurality of inner electrode layers and the base electrode layer are in contact with each other at the exposed surfaces.

4. The multilayer ceramic capacitor according to claim 3, wherein the base electrode layer includes a glass component and a metal component.

5. The multilayer ceramic capacitor according to claim 1, wherein a number of the plurality of dielectric layers is not less than 15 and not more than 700.

6. The multilayer ceramic capacitor according to claim 1, wherein
a dimension of the multilayer body in the length direction is preferably not less than about 0.2 mm and not more than about 10.0 mm;
a dimension of the multilayer body in the width direction is preferably not less than about 0.1 mm and not more than about 10.0 mm; and
a dimension of the multilayer body in the height direction x is preferably not less than about 0.1 mm and not more than about 5.0 mm.

7. The multilayer ceramic capacitor according to claim 1, wherein the plurality of dielectric layers includes a Mn compound, an Fe compound, a Cr compound, a Co compound, or a Ni compound as a secondary component.

8. The multilayer ceramic capacitor according to claim 1, wherein a thickness of each of the plurality of dielectric layers is not less than about 0.4 μm and not more than about 10.0 μm.

9. The multilayer ceramic capacitor according to claim 1, wherein a thickness of each of the plurality of inner electrode layers is not less than about 0.2 μm and not more than about 2.0 μm.

10. The multilayer ceramic capacitor according to claim 3, wherein
an alloy layer is provided on the exposed surfaces; and
the alloy layer is denser than the plurality of inner electrode layers and the base electrode layers.

11. A method for manufacturing a multilayer ceramic capacitor, the method comprising:
preparing, through firing, a multilayer body including a plurality of laminated ceramic layers including a perovskite compound represented by a general formula ABO₃, where an A-site is Ba, a plurality of laminated inner electrode layers, and a first main surface and a second main surface which oppose each other in a height direction, a first side surface and a second side surface which oppose each other in a width direction perpendicular or substantially perpendicular to the height direction, and a first end surface and a second end surface which oppose each other in a length direction perpendicular or substantially perpendicular to the height direction and the width direction;
forming a barrier film, including Ba and at least one of S or C, on the multilayer body by immersing the multilayer body in a solution including at least one of S ions and C ions; and
forming outer electrodes on the barrier film at the first end surface and the second end surface;
the barrier film covers the first main surface, the second main surface, the first side surface, and the second side surface, and also covers the first end surface and the second end surface except for exposed surfaces of the first end surface and the second end surface where the inner electrode layers are exposed in the multilayer body; and
the outer electrodes are in contact with the plurality of inner electrode layers at the exposed surfaces.

12. The method for manufacturing a multilayer ceramic capacitor according to claim 11, wherein the barrier film is made of at least one of barium sulfate or barium carbonate.

13. The method for manufacturing a multilayer ceramic capacitor according to claim 11, wherein
the plurality of inner electrode layers include Ni as a main component;
the outer electrodes include a base electrode layer including Cu as a main component, and a plating layer on the base electrode layer; and
the plurality of inner electrode layers and the base electrode layer are in contact with each other at the exposed surfaces.

14. The method for manufacturing a multilayer ceramic capacitor according to claim 13, wherein the base electrode layer includes a glass component and a metal component.

15. The method for manufacturing a multilayer ceramic capacitor according to claim 11, wherein a number of the plurality of dielectric layers is not less than 15 and not more than 700.

16. The method for manufacturing a multilayer ceramic capacitor according to claim 11, wherein
a dimension of the multilayer body in the length direction is not less than about 0.2 mm and not more than about 10.0 mm;
a dimension of the multilayer body in the width direction is not less than about 0.1 mm and not more than about 10.0 mm; and
a dimension of the multilayer body in the height direction x is not less than about 0.1 mm and not more than about 5.0 mm.

17. The method for manufacturing a multilayer ceramic capacitor according to claim 11, wherein the plurality of dielectric layers includes a Mn compound, an Fe compound, a Cr compound, a Co compound, or a Ni compound as a secondary component.

18. The method for manufacturing a multilayer ceramic capacitor according to claim 11, wherein a thickness of each of the plurality of dielectric layers is not less than about 0.4 μm and not more than about 10.0 μm.

19. The method for manufacturing a multilayer ceramic capacitor according to claim 11, wherein a thickness of each of the plurality of inner electrode layers is not less than about 0.2 μm and not more than about 2.0 μm.

20. The method for manufacturing a multilayer ceramic capacitor according to claim 13, wherein
an alloy layer is provided on the exposed surfaces; and
the alloy layer is denser than the plurality of inner electrode layers and the base electrode layers.
